(19) United States
(12) Patent Application Publication
(10) Pub. No.: US 2007/0173428 A1
(43) Pub. Date: Jul. 26, 2007

(54) Composition comprising a pre-formed peroxyacid and a bleach catalyst

(75) Inventors: Doris Appleby, Newcastle upon Tyne (GB); Andrew Paul Nelson, Newcastle upon Tyne (GB); Alan Thomas Brooker, Newcastle upon Tyne (GB)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/656,841

(22) Filed: Jan. 23, 2007

(30) Foreign Application Priority Data
Jan. 23, 2006 (EP) 06001312.5

(51) Int. Cl. C11D 3/39

(52) U.S. Cl. 510/309; 510/311; 510/313; 510/375

(57) ABSTRACT

The present invention relates to a composition comprising: (i) a pre-formed peroxyacid or salt thereof in molecularly encapsulated form; and (ii) a bleach catalyst that is capable of accepting an oxygen atom from a peroxyacid and transferring the oxygen atom to an oxidizeable substrate.

### FIELD OF THE INVENTION

The present invention relates to a composition comprising a pre-formed peroxyacid and a bleach catalyst. More specifically, the present invention relates to composition comprising a pre-formed peroxyacid in molecularly encapsulated form and a bleach catalyst that is capable of accepting an oxygen atom from a peroxyacid and transferring the oxygen atom to an oxidizeable substrate. The compositions of the present invention are typically suitable for use as laundry detergent compositions and exhibit a good dye safety profile, an excellent bleaching performance, an especially good dingy cleaning performance, and a good overall cleaning performance, even after prolonged storage of the composition in stressed conditions.

### BACKGROUND OF THE INVENTION

Dingy soils such as fatty body soils and other hydrophobic soils are extremely difficult to remove from fabric during a laundering process. Detergent manufacturers have attempted to incorporate cleaning technologies such as pre-formed peroxyacids into their detergent products in an attempt to improve the dingy cleaning performance. However, these technologies are intrinsically unstable and their performance significantly deteriorates after storage, especially after prolonged storage in stressed conditions such as in high moisture and/or high temperature environments: pre-formed peroxyacids readily undergo autocatalytic thermal decomposition.

Attempts have been made to overcome the problems associated with the intrinsic instability of pre-formed peroxyacids by molecularly encapsulating the pre-formed peroxyacid, for example using a urea clathrated peroxyacid: U.S. Pat. No. 3,167,513 by van Embden et al., Lever Brothers, and U.S. Pat. No. 4,529,535 by Richardson, The Procter & Gamble Company, both relate to urea clathrated peroxyacids. However, these urea clathrated peroxyacids do not show adequate bleaching performance and they do not provide a good bleaching performance.

Detergent manufacturers have also attempted to incorporate bleach catalysts, especially oxaziridium or oxaziridinium-forming bleach catalysts, in their detergent products in an attempt to provide a good bleaching performance. However, these bleach catalysts reduce the dye safety profile of the detergent composition resulting in the premature fading of coloured fabrics after multiple laundering cycles. These bleach catalysts are also incompatible with some other detergent ingredients such as protease, that may be present in the composition. This incompatibility results in the premature degradation of detergent ingredients such as protease, especially after prolonged storage in stressed conditions.

EP 0 728 181, EP 0 728 182, EP 0 728 183, EP 0 775 192, U.S. Pat. No. 4,678,792, U.S. Pat. No. 5,045,223, U.S. Pat. No. 5,047,163, U.S. Pat. No. 5,360,568, U.S. Pat. No. 5,360,569, U.S. Pat. No. 5,370,826, U.S. Pat. No. 5,442,066, U.S. Pat. No. 5,478,357, U.S. Pat. No. 5,482,515, U.S. Pat. No. 5,550,256, U.S. Pat. No. 5,653,910, U.S. Pat. No. 5,710,116, U.S. Pat. No. 5,760,222, U.S. Pat. No. 5,785,886, U.S. Pat. No. 5,952,282, U.S. Pat. No. 6,042,744, WO95/13351, WO95/13353, WO97/10323, WO98/16614, WO00/42151, WO00/42156, WO01/16110, WO01/16263, WO01/16273, WO01/16274, WO01/16275, WO01/16276, WO01/16277 relate to detergent compositions comprising an oxaziriduium and/or an oxaziridinium-forming bleach catalyst.

There is a continuing need for laundry detergent compositions that, even after prolonged storage in stressed conditions, exhibit excellent dingy cleaning, have an excellent dye safety profile and have a bleach system that is compatible with the remainder of the detergent ingredients present in the composition to ensure a good overall cleaning performance.

The Inventors have found that by using molecularly encapsulated pre-formed peroxyacid in combination with a bleach catalyst that is capable of accepting an oxygen atom from a peroxyacid and transferring the oxygen atom to an oxidizeable substrate significantly improves the bleaching performance of the detergent composition whilst maintaining a good dye safety profile and bleach compatibility; this results in a composition having very good dingy cleaning performance, a good overall cleaning performance and a good dye safety profile.

### SUMMARY OF THE INVENTION

In a first embodiment, the present invention provides a composition comprising: (i) a pre-formed peroxyacid or salt thereof in molecularly encapsulated form; and (ii) a bleach catalyst that is capable of accepting an oxygen atom from a peroxyacid and transferring the oxygen atom to an oxidizeable substrate.

In a second embodiment, the present invention provides a composition comprising: (i) the clathrated product of contacting a pre-formed peroxyacid or salt thereof with urea; and (ii) a bleach catalyst that is capable of accepting an oxygen atom from a peroxyacid and transferring the oxygen atom onto a substrate to be bleached.

### DETAILED DESCRIPTION OF THE INVENTION

### Composition

The composition comprises: (i) a pre-formed peroxyacid or salt thereof in molecularly encapsulated form; and (ii) a bleach catalyst that is capable of accepting an oxygen atom from a peroxyacid and transferring the oxygen atom to an oxidizeable substrate. The pre-formed peroxyacid and the bleach catalyst are described in more detail below.

The composition may be suitable for use as a laundry detergent composition, laundry additive composition, dish-washing composition, or hard surface cleaning composition. The composition is typically a detergent composition. The composition may be a fabric treatment composition. Preferably the composition is a laundry detergent composition.

The composition can be any form such as liquid or solid, although preferably the composition is in solid form. Typically, the composition is in particulate form such as an agglomerate, a spray-dried powder, an extrudate, a flake, a needle, a noodle, a bead, or any combination thereof. The composition may be in compacted particulate form, such as in the form of a tablet or bar. The composition may in some other unit dose form, such as in the form of a pouch, wherein the composition is typically at least, preferably essentially completely, enclosed by a water-soluble film such as polyvinyl alcohol. Preferably, the composition is in free-flowing particulate form; by free-flowing particulate form, it is typically meant that the composition is in the form of separate discrete particles. The composition may be made by any suitable method including agglomeration, spray-drying, extrusion, mixing, dry-mixing, liquid spray-on, roller compaction, spheronisation, tabletting or any combination thereof.

The composition typically has a bulk density of from 450 g/l to 1,000 μl, preferred low bulk density detergent compositions have a bulk density of from 550 g/l to 650 g/l and preferred high bulk density detergent compositions have a bulk density of from 750 g/l to 900 g/l. The composition may also have a bulk density of from 650 g/l to 750 g/l. During the laundering process, the composition is typically contacted with water to give a wash liquor having a pH of from above 7 to less than 13, preferably from above 7 to less than 10.5. This is the optimal pH to provide good cleaning whilst also ensuring a good fabric care profile.

Preferably, the composition comprises a pre-formed peroxyacid in a sufficient amount so as to provide from above 0%, preferably from 0.01%, preferably to 0.2%, by weight of the composition, of available oxygen. The incorporation of the pre-formed peroxyacid into a composition having the above described low levels of available oxygen provides a composition that has a surprisingly (in view of the very low level of available oxygen) excellent bleaching performance and a good dye safety profile.

Typically, the available oxygen content of the composition is determined by the following method: 0.5 g of composition is placed into a 150 ml beaker, 60 ml of isopropanol is added and the mixture is warmed to 50° C. to achieve dissolution. 10 ml of glacial acetic acid and 7 g of solid potassium iodine are added, stirred and heated at 60° C. for 10 min. The resulting mixture is covered and placed in the dark for 5 min. The mixture is topped up with isopropanol up to 100 ml and titrated with 0.1 M sodium thiosulphate. The titration can be carried out with an auto-titrator and electrochemical detection using a Mettler DM 140-SC electrode. A blank is prepared using the same reagents. The available oxygen content is then calculated as follows:

% available oxygen=(titration−blank)×0.1×16×100/(0.5×2000)

Preferably, the composition comprises from 0% to 20%, or to 10%, or to 5%, or to 4%, or to 3%, or to 2%, or to 1%, by weight of the composition, of percarbonate salts and/or perborate salts. Most preferably, the composition is essentially free of percarbonate salts and/or perborate salts. By “essentially free of percarbonate salts and/or perborate salts” it is typically meant that the composition comprises no deliberately incorporated percarbonate salts and/or perborate salts. The combination of the pre-formed peroxyacid and the bleach catalyst provides adequate bleaching performance: the need for further bleaching species such as percarbonate salts and/or perborate salts is negated. Keeping the level of percarbonate salts and/or perborate salts to a minimum maintains the good dye safety profile of the composition.

Preferably, the composition comprises: (i) from 0% to less than 5%, preferably less than 4%, or less than 3%, or less than 2%, or less than 1%, by weight of the composition, of tetraacetylethylenediamine and/or oxybenzene sulphonate bleach activators. Most preferably, the composition is essentially free of tetraacetylethylenediamine and/or oxybenzene sulphonate bleach activators. By “is essential free of” it is typically meant “comprises no deliberately incorporated”. Keeping the levels of these types of bleach activators to a minimum maintains the good dye safety profile of the composition.

Preferably, upon contact with water the composition forms a wash liquor having a pH of from 7 to 10.5. Compositions having this reserve alkalinity profile and pH profile exhibit a good stability profile for pre-formed peroxyacid.

Preferably, the composition comprises from 0% or from 1%, or from 2%, or from 3%, or from 4%, or from 5%, and to 30%, or to 20%, or to 10%, by weight of the composition, of a source of carbonate anion. The above described levels of a source of carbonate anion ensure that the composition has a good overall cleaning performance and a good bleaching performance.

Preferably, the composition comprises a dye transfer inhibitor. Suitable dye transfer inhibitors are selected from the group consisting of: polyvinylpyrrolidone, preferably having a weight average molecular weight of from 40,000 Da to 80,000 Da, preferably from 50,000 D1 to 70,000 Da; polyvinylimidazole, preferably having a weight average molecular weight of from 10,000 Da to 40,000 Da, preferably from 15,000 Da to 25,000 Da; polyvinyl pyridine N-oxide polymer, preferably having a weight average molecular weight of from 30,000 Da to 70,000 Da, preferably from 40,000 Da to 60,000 Da; a co-polymer of polyvinylpyrrolidone and vinyl imidazole, preferably having a weight average molecular weight of from 30,000 Da to 70,000 Da, preferably from 40,000 Da to 60,000 Da; and any combination thereof. Compositions comprising a dye transfer inhibitor show a further improved dye safety profile.

The composition may comprise from 0% to less than 5%, preferably to 4%, or to 3%, or to 2%, or even to 1%, by weight of the composition, of zeolite-builder. Whilst the composition may comprise zeolite-builder at a level of 5 wt % or greater, preferably the composition comprises less than 5 wt % zeolite-builder. It may be preferred for the composition to be essentially free of zeolite-builder. By: “essentially free of zeolite-builder”, it is typically meant that the composition comprises no deliberately incorporated zeolite-builder. This is especially preferred when the composition is a solid laundry detergent composition and it is desirable for the composition to be very highly soluble, to minimize the amount of water-insoluble residues (for example, which may deposit on fabric surfaces), and also when it is highly desirable to have transparent wash liquor. Suitable zeolite-builders include zeolite A, zeolite X, zeolite P and zeolite MAP.

The composition may comprise from 0% to less than 5%, preferably to 4%, or to 3%, or to 2%, or even to 1%, by weight of the composition, of phosphate-builder. Whilst the composition may comprise phosphate-builder at a level of 5 wt % or greater, preferably the composition comprises less than 5 wt % phosphate-builder. It may even be preferred for the composition to be essentially free of phosphate-builder. By: “essentially free of phosphate-builder”, it is typically meant that the composition comprises no deliberately added phosphate-builder. This is especially preferred if it is desirable for the composition to have a very good environmental profile. Suitable phosphate-builders include sodium tripolyphosphate.

The composition may comprise from 0% to less than 5%, or preferably to 4%, or to 3%, or even to 2%, or to 1%, by weight of the composition, of silicate salt. Whilst the composition may comprise silicate salt at a level of 5 wt % or greater, preferably the composition comprises less than 5 wt % silicate salt. It may even be preferred for the composition to be essentially free of silicate salt. By: “essentially free from silicate salt”, it is typically meant that the composition comprises no deliberately added silicate salt. This is especially preferred when the composition is a solid laundry detergent composition and it is desirable to ensure that the composition has very good dispensing and dissolution profiles and to ensure that the composition provides a clear wash liquor upon dissolution in water. The silicate salts include water-insoluble silicate salts. The silicate salts also include amorphous silicate salts and crystalline layered silicate salts (e.g. SKS-6). The silicate salts include sodium silicate.

The composition typically comprises adjunct ingredients. These adjunct ingredients include: detersive surfactants such as anionic detersive surfactants, non-ionic detersive surfactants, cationic detersive surfactants, zwitterionic detersive surfactants, amphoteric detersive surfactants; preferred anionic detersive surfactants are alkoxylated anionic detersive surfactants such as linear or branched, substituted or unsubstituted C₁₂₋₁₈ alkyl alkoxylated sulphates having an average degree of alkoxylation of from 1 to 30, preferably from 1 to 10, more preferably a linear or branched, substituted or unsubstituted C₁₂₋₁₈ alkyl ethoxylated sulphates having an average degree of ethoxylation of from 1 to 10, most preferably a linear unsubstituted C₁₂₋₁₈ alkyl ethoxylated sulphates having an average degree of ethoxylation of from 3 to 7, other preferred anionic detersive surfactants are alkyl sulphates, alkyl sulphonates, alkyl phosphates, alkyl phosphonates, alkyl carboxylates or any mixture thereof, preferred alkyl sulphates include linear or branched, substituted or unsubstituted C₁₀₋₈ alkyl sulphates, another preferred anionic detersive surfactant is a C₁₀₋₁₃ linear alkyl benzene sulphonate; preferred non-ionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activators such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide; enzymes such as amylases, carbohydrases, cellulases, laccases, lipases, oxidases, peroxidases, proteases, glucanases, pectate lyases and mannanases, especially preferred are proteases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds, especially preferred is montmorillonite clay optionally in combination with a silicone; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; carbonate salts, especially preferred is sodium carbonate; and dyes such as orange dye, blue dye, green dye, purple dye, pink dye, or any mixture thereof.

A second embodiment of the present invention relates to a composition comprising: (i) a clathrate compound obtainable by contacting a pre-formed peroxyacid or salt thereof with urea; and (ii) a bleach catalyst that is capable of accepting an oxygen atom from a peroxyacid and transferring the oxygen atom onto a substrate to be bleached.

### Pre-Formed Peroxyacid or Salt Thereof.

The pre-peroxyacid or salt thereof is typically either a peroxycarboxylic acid or salt thereof, or a peroxysulphonic acid or salt thereof.

The pre-formed peroxyacid or salt thereof is preferably a peroxycarboxylic acid or salt thereof, typically having a chemical structure corresponding to the following chemical formula:

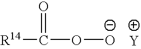

wherein: R¹⁴ is selected from alkyl, aralkyl, cycloalkyl, aryl or heterocyclic groups; the R¹⁴ group can be linear or branched, substituted or unsubstituted; and Y is any suitable counter-ion that achieves electric charge neutrality, preferably Y is selected from hydrogen, sodium or potassium. Preferably, R¹⁴ is a linear or branched, substituted or unsubstituted C₆₋₉ alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Preferably, the peroxyacid or salt thereof has a melting point in the range of from 30° C. to 60° C.

The pre-formed peroxyacid or salt thereof can also be a peroxysulphonic acid or salt thereof, typically having a chemical structure corresponding to the following chemical formula:

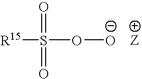

wherein: R¹⁵ is selected from alkyl, aralkyl, cycloalkyl, aryl or heterocyclic groups; the R¹⁵ group can be linear or branched, substituted or unsubstituted; and Z is any suitable counter-ion that achieves electric charge neutrality, preferably Z is selected from hydrogen, sodium or potassium. Preferably R¹⁵ is a linear or branched, substituted or unsubstituted C₆₋₉ alkyl.

The pre-formed peroxyacid or salt thereof is in a molecularly encapsulated form. Typically, the pre-formed peroxyacid molecules are individually separated from each other by any suitable molecular encapsulation means.

Preferably, the pre-formed peroxyacid is a guest molecule in a host-guest complex. Typically, the host molecule of the host-guest complex comprises, or is capable of forming (e.g. by their intermolecular configuration), a cavity into which the pre-formed peroxyacid molecule can be located. The host molecule is typically in the form of a relatively open structure which provides a cavity that may be occupied by a pre-formed peroxyacid molecule: thus forming the host-guest complex. The pre-formed peroxyacid molecule may become entrapped by one or more host molecules, for example by the formation of a clathrate compound, also typically known as inclusion compound, cage compound, molecular compound, intercalation compound or adduct.

The host molecule is typically capable of forming hydrogen bonds: such as intramolecular hydrogen bonds or intermolecular hydrogen bonds. Preferably, the host molecule is capable of forming intermolecular hydrogen bonds.

Suitable host molecules include: urea; cyclodextrins, particularly beta-cyclodextrins; thiourea; hydroquinone; perhydrotriphenylene; deoxycholic acid; triphenylcarbinol; calixarene; zeolites, particularly wide-pore zeolites; and any combination thereof. The host molecules are most preferably water-soluble; this is desirable so as to enable the effective release and dispersion of the pre-formed peroxyacid on introduction of the host-guest complex into an aqueous environment, such as a wash liquor. Preferably, the host molecule is urea or thiourea, especially preferably the host molecule is urea.

The host-guest complex is preferably at least partially, preferably essentially completely, coated by a coating ingredient; this is desirable so as to further improve the stability of the pre-formed peroxyacid. Typically, the coating ingredient is essentially incapable of forming hydrogen bonds; this helps ensure the optimal intermolecular configuration of the host molecules, especially when the host-guest complex is a clathrate compound, and further improves the stability of the pre-formed peroxyacid. Typically, the coating ingredient is chemically compatible with the host-guest complex and has a suitable release profile, especially an appropriate melting point range: the melting point range of the coating ingredient is preferably from 35° C. to 60° C., more preferably from 40° C. to 50° C., or from 46° C. to 68° C. Suitable coating ingredients include paraffin waxes, semi-microcrystalline waxes (also typically known as intermediate-microcrystalline waxes), microcrystalline waxes and natural waxes. Preferred paraffin waxes include: Merck® 7150 and Merck® 7151 supplied by E. Merck of Darmstadt, Germany; Boler® 1397, Boler® 1538 and Boler® 1092 supplied by Boler of Wayne, Pa.; Ross® fully refined paraffin wax 115/120 supplied by Frank D. Ross Co., Inc of Jersey City, N.J.; Tholler® 1397 and Tholler® 1538 supplied by Tholler of Wayne, Pa.; Paramelt® 4608 supplied by Terhell Paraffin of Hamburg, Germany and Paraffin® R7214 supplied by Moore & Munger of Shelton, Conn. Preferred paraffin waxes typically have a melting point in the range of from 46° C. to 68° C., and they typically have a number average molecular weight in the range of from 350 Da to 420 Da. Also suitable are: natural waxes, such as natural bayberry wax, having a melting point in the range of from 42° C. to 48° C. supplied by Frank D. Ross Co., Inc.; synthetic substitutes of natural waxes, such as synthetic spermaceti wax, having a melting point in the range of from 42° C. to 50° C., supplied by Frank D. Ross Co., Inc., synthetic beeswax (BD4) and glyceryl behenate (HRC) synthetic wax. Other suitable coating ingredients include fatty acids, especially hydrogenated fatty acids. However, most preferably the coating ingredient is a paraffin wax.

Typically, the host-guest complex is in an intimate mixture with a source of acid. Typically, the host-guest complex and the source of acid are in particulate form, preferably being in a co-particulate mixture with each other: typically both are present in the same particle. Preferred sources of acid include: fatty acids, especially hydrogenated fatty acids, which may also be suitable coating ingredients and are described above; carboxylic acids, including mono-carboxylic acids, and poly-carboxylic acids such as di-carboxylic acids and tri-carboxylic acids. Preferably, the source of acid is a bi-carboxylic acid.

It may be preferred for the host-guest complex to be in an intimate mixture with a free radical scavenger. A suitable free radical scavenger is butylated hydroxytoluene.

### Bleach Catalyst

The bleach catalyst is capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulphonate, prepared as described in U.S. Pat. No. 5,360,569 (see, for example, Column 11, Example 1); and N-octyl-3,4-dihydroisoquinolinium p-toluene sulphonate, prepared as described in U.S. Pat. No. 5,360,568 (see, for example, Column 10, Example 3).

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); N-[2-(sulphooxy)dodecyl]-3,4-dihydroisoquinolinium, inner salt, prepared as described in U.S. Pat. No. 5,817,614 (see, for example, Column 32, Example V); 2-[3-[(2-ethylhexyl)oxy]-2-(sulphooxy)propyl]-3,4-dihydroisoquinolinium, inner salt, prepared as described in WO05/047264 (see, for example, page 18, Example 8), and 2-[3-[(2-butyloctyl)oxy]-2-(sulphooxy)propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy)decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70.

Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Example 2).

Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Example 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof.

Preferably, the bleach catalyst has a chemical structure corresponding to the following chemical formula

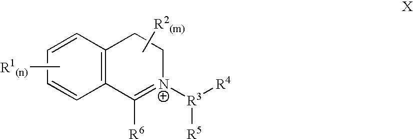

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}-[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubsituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can=0 or 1, but c must=0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

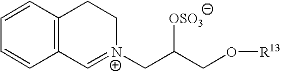

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

### EXAMPLES

### Example 1

### Preparation of Sulphuric acid mono-[2-(3,4-dihydro-isoquinolin-2-yl)-1-(2-ethylhexyloxymethyl-ethyl]ester Internal Salt

Preparation of 2-ethylhexyl glycidyl ether: To a flame dried, 500 mL round bottomed flask equipped with an addition funnel charged with epichlorohydrin (15.62 g, 0.17 moles), is added 2-ethylhexanol (16.5 g, 0.127 moles) and stannic chloride (0.20 g, 0.001 moles). The reaction is kept under an argon atmosphere and warmed to 90° C. using an oil bath. Epichlorohydrin is dripped into the stirring solution over 60 minutes followed by stirring at 90° C. for 18 hours. The reaction is fitted with a vacuum distillation head and 1-chloro-3-(2-ethyl-hexyloxy)-propan-2-ol is distilled under 0.2 mm Hg. The 1-chloro-3-(2-ethyl-hexyloxy)-propan-2-ol (4.46 g, 0.020 moles) is dissolved in tetrahydrofuran (50 mL) and stirred at room temperature under an argon atmosphere. To the stirring solution is added potassium tert-butoxide (2.52 g, 0.022 moles) and the suspension is stirred at room temperature for 18 hours. The reaction is then evaporated to dryness, residue dissolved in hexanes and washed with water (100 mL). The hexanes phase is separated, dried with Na₂SO₄, filtered and evaporated to dryness to yield the crude 2-ethylhexyl glycidyl ether, which can be further purified by vacuum distillation.

Preparation of Sulphuric acid mono-[2-(3,4-dihydro-isoquinolin-2-yl)-1-(2-ethylhexyloxymethyl)-ethyl]ester, internal salt: To a flame dried 250 mL three neck round bottomed flask, equipped with a condenser, dry argon inlet, magnetic stir bar, thermometer, and heating bath is added 3,4-dihydroisoquinoline (0.40 mol.; prepared as described in Example I of U.S. Pat. No. 5,576,282), 2-ethylhexyl glycidyl ether (0.38 mol, prepared as described above), SO₃-DMF complex (0.38 mol), and acetonitrile (500 mL). The reaction is warmed to 80° C. and stirred at temperature for 72 hours. The reaction is cooled to room temperature, evaporated to dryness and the residue recrystallized from ethyl acetate and/or ethanol to yield the desired product. The solvent acetonitrile may be replaced with other solvents, including but not limited to, 1,2-dichloroethane.

### Example 2

### Preparation of Sulphuric acid mono-[2-(3,4-dihydro-isoquinolin-2-yl)-1-(2-butyl-octyloxymethyl)-ethyl]ester Internal Salt

The desired product is prepared according to Example I but substituting 2-butyloctanol for 2-hexyloctanol.

### Example 3

### Preparation of Urea Clathrated Pernonanoic Acid

25 g of nonanoic acid is dissolved in 31.5 g of concentrated sulphuric acid to form a mixture. The mixture is cooled to room temperature. 16.16 g of a 50 w/w % aqueous hydrogen peroxide solution is added dropwise to the mixture in a manner such that the temperature of the mixture does not exceed 25° C. The resulting mixture is stirred for 1 hour to form a pemonanoic acid mixture. Separately, 100 g of urea is dissolved into 300 ml of methanol at 40° C.; this mixture is then added to the pernonanoic acid mixture and the resulting mixture is cooled immediately to a temperature of less than 25° C. The mixture is filtered and the residue (which contains the urea clathrated pernonanoic acid) is collected and dried under vacuum.

### Example 4

### Laundry Detergent Compositions

The following laundry detergent compositions A, B, C and D are suitable for use in the present invention. Typically, these compositions are dosed into water at a concentration of from 0.4 g/l to 12 g/l during the laundering process.

| Ingredient | A | | B | | C | | D | |
|---|---|---|---|---|---|---|---|---|
| Bleach catalyst made according to | 0.1 | wt % | 0.05 | wt % | 0.01 | wt % | 0.05 | wt % |
| example 1 or 2 | | | | | | | | |
| Urea clathrated pernonanoic acid | 1.0 | wt % | 0.5 | wt % | 0.75 | wt % | 0.25 | wt % |
| made according to example 3 | | | | | | | | |
| Sodium linear C_{12–13} alkyl | 9.0 | wt % | 9.5 | wt % | 7.5 | wt % | 7.0 | wt % |
| benzenesulphonate (LAS) | | | | | | | | |
| Tallow alkyl sulphate (TAS) | 1.0 | wt % | 0.75 | wt % | | | | |
| C_{14–15} alkyl ethoxylated alcohol | 2.5 | wt % | 2.0 | wt % | | | | |
| having an average degree of | | | | | | | | |
| ethoxylation of 7 (AE7) | | | | | | | | |
| C_{14–15} alkyl ethoxylated alcohol | | | | | 5 | wt % | 2.5 | wt % |
| sulphate having an average degree of | | | | | | | | |
| ethoxylation of 3 (AE₃S) | | | | | | | | |
| Mono-C_{12–14} alkyl mono- | 1.5 | wt % | 1.0 | wt % | | | | |
| hydroxyethyl di-methyl quaternary | | | | | | | | |
| ammonium chloride | | | | | | | | |
| Zeolite 4A | 15 | wt % | 12.5 | wt % | | | | |
| Citric Acid | 3.0 | wt % | 2.0 | wt % | | | | |
| Sodium carbonate | 20 | wt % | 25 | wt % | 10 | wt % | 15 | wt % |
| Polymeric carboxylate | 2.0 | wt % | 1.5 | wt % | 3.0 | wt % | 2.5 | wt % |
| A compound having the following general structure: | 1.0 | wt % | 0.5 | wt % | 0.75 | t % | 1.0 | wt % |
| bis((C₂H₅O)(C₂H₄O)n)(CH₃)—N⁺—CₓH₂ₓ—N⁺—(CH₃)-bis((C₂H₅O)(C₂H₄O)n), | | | | | | | | |
| wherein n = from 20 to 30, and x = from 3 to 8, or sulphated or | | | | | | | | |
| sulphonated variants thereof | | | | | | | | |
| Carboxymethyl cellulose | | | | | 1.5 | wt % | 1.0 | wt % |
| Enzymes | 1.0 | wt % | 0.5 | wt % | 0.75 | wt % | 0.5 | wt % |
| Ethylene diamine disuccinic acid | 0.5 | wt % | 0.1 | wt % | 0.2 | wt % | 0.25 | wt % |
| Magnesium sulphate | 0.75 | wt % | 0.5 | wt % | 1.0 | wt % | 0.5 | wt % |
| Hydroxyethane di(methylene | 0.5 | wt % | 0.25 | wt % | 0.2 | wt % | 1.0 | wt % |
| phosphonic acid) | | | | | | | | |
| Fluorescent whitening agent | 0.2 | wt % | 0.1 | wt % | 0.15 | wt % | 0.25 | wt % |
| Silicone suds suppressing agent | 0.1 | wt % | 0.05 | wt % | 0.1 | wt % | 0.2 | wt % |
| Soap | 0.5 | wt % | 0.25 | wt % | 1.0 | wt % | 0.5 | wt % |
| Photobleach | 0.01 | wt % | 0.0001 | wt % | 0.0005 | wt % | 0.0015 | wt % |
| Perfume | 1.0 | wt % | 0.5 | wt % | 0.75 | wt % | 0.5 | wt % |
| Sodium sulphate | 30 | wt % | 32.5 | wt % | 60 | wt % | 55 | wt % |
| Water and miscellaneous | To 100 | wt % | to 100 | wt % | to 100 | wt % | to 100 | wt % |

The following laundry detergent compositions E, F, G and H are suitable for use in the present invention. Typically, these compositions are dosed into water at a concentration of from 0.4 g/l to 12 g/l during the laundering process.

| Ingredient | E | | F | | G | | H | |
|---|---|---|---|---|---|---|---|---|
| Bleach catalyst made according to | 0.1 | wt % | 0.05 | wt % | 0.01 | wt % | 0.05 | wt % |
| example 1 or 2 | | | | | | | | |
| Urea clathrated pernonanoic acid | 1.0 | wt % | 0.5 | wt % | 0.75 | wt % | 0.25 | wt % |
| made according to example 3 | | | | | | | | |
| Sodium linear C_{12–13} alkyl | 8.0 | wt % | 5.0 | wt % | 7.5 | wt % | 6.0 | wt % |
| benzenesulphonate (LAS) | | | | | | | | |
| C_{14–15} alkyl ethoxylated alcohol | 5.0 | wt % | 2.5 | wt % | 3.5 | wt % | 6.0 | wt % |
| sulphate having an average degree of | | | | | | | | |
| ethoxylation of 3 (AE₃S) | | | | | | | | |
| Citric Acid | 3.0 | wt % | 2.0 | wt % | 5.0 | wt % | 2.5 | wt % |
| Sodium carbonate | 20 | wt % | 25 | wt % | 22.5 | wt % | 30 | wt % |
| Polymeric carboxylate | 2.0 | wt % | 3.5 | wt % | 4.0 | wt % | 2.5 | wt % |
| A compound having the following general structure: | 1.0 | wt % | 0.5 | wt % | 0.75 | wt % | 1.0 | wt % |
| bis((C₂H₅O)(C₂H₄O)n)(CH₃)—N⁺—CₓH₂ₓ—N⁺—(CH₃)-bis((C₂H₅O)(C₂H₄O)n), | | | | | | | | |
| wherein n = from 20 to 30, and x = from 3 to 8, or sulphated | | | | | | | | |
| or sulphonated variants thereof | | | | | | | | |
| Carboxymethyl cellulose | 0.5 | wt % | 1.0 | wt % | 1.5 | wt % | 1.0 | wt % |
| Enzymes | 1.0 | wt % | 0.5 | wt % | 0.2 | wt % | 0.5 | wt % |
| Ethylene diamine disuccinic acid | 0.05 | wt % | 0.1 | wt % | 0.2 | wt % | 0.15 | wt % |
| Magnesium sulphate | 0.35 | wt % | 0.1 | wt % | 1.0 | wt % | 0.25 | wt % |
| Hydroxyethane di(methylene | 0.1 | wt % | 0.25 | wt % | 0.2 | wt % | 0.5 | wt % |
| phosphonic acid) | | | | | | | | |
| Fluorescent whitening agent | 0.2 | wt % | 0.1 | wt % | 0.15 | wt % | 0.25 | wt % |
| Silicone suds suppressing agent | 0.1 | wt % | 0.05 | wt % | 0.1 | wt % | 0.2 | wt % |
| Soap | 0.5 | wt % | 0.25 | wt % | 1.0 | wt % | 0.5 | wt % |
| Photobleach | 0.01 | wt % | 0.0001 | wt % | 0.0005 | wt % | 0.0015 | wt % |
| Perfume | 1.0 | wt % | 0.5 | wt % | 0.75 | wt % | 0.5 | wt % |
| Sodium sulphate | 45 | wt % | 50 | wt % | 40 | wt % | 35 | wt % |
| Water and miscellaneous | to 100 | wt % | to 100 | wt % | to 100 | wt % | to 100 | wt % |

The following laundry detergent compositions I, J, K and L are suitable for use in the present invention. Typically, these compositions are dosed into water at a concentration of from 1 g/l to 5 g/l during the laundering process.

| Ingredient | I | | J | | K | | L | |
|---|---|---|---|---|---|---|---|---|
| Bleach catalyst made according to | 0.15 | wt % | 0.10 | wt % | 0.2 | wt % | 0.05 | wt % |
| example 1 or 2 | | | | | | | | |
| Urea clathrated pernonanoic acid | 1.25 | wt % | 0.5 | wt % | 2.0 | wt % | 0.5 | wt % |
| made according to example 3 | | | | | | | | |
| Sodium linear C_{12–13} alkyl | 15 | wt % | 17.5 | wt % | 20 | wt % | 7.0 | wt % |
| benzenesulphonate (LAS) | | | | | | | | |
| C_{14–15} alkyl ethoxylated alcohol | 7.0 | wt % | 7.5 | wt % | 5.0 | wt % | 3.0 | wt % |
| sulphate having an average degree of | | | | | | | | |
| ethoxylation of 3 (AE₃S) | | | | | | | | |
| Citric Acid | 7.0 | wt % | 5.0 | wt % | 7.5 | wt % | 3.0 | wt % |
| Sodium carbonate | 22.5 | wt % | 25 | wt % | 20 | wt % | 10 | wt % |
| Polymeric carboxylate | 7.0 | wt % | 7.5 | wt % | 5.0 | wt % | 3.0 | wt % |
| A compound having the following general structure: | 2.5 | wt % | 1.5 | wt % | 3.0 | wt % | 1.0 | wt % |
| bis((C₂H₅O)(C₂H₄O)n)(CH₃)—N⁺—CₓH₂ₓ—N⁺—(CH₃)-bis((C₂H₅O)(C₂H₄O)n), | | | | | | | | |
| wherein n = from 20 to 30, and x = from 3 to 8, or sulphated or | | | | | | | | |
| sulphonated variants thereof | | | | | | | | |
| Carboxymethyl cellulose | 2.5 | wt % | 3.0 | wt % | 1.5 | wt % | 1.0 | wt % |
| Enzymes | 2.5 | wt % | 1.5 | wt % | 3.0 | wt % | 0.75 | wt % |
| Ethylene diamine disuccinic acid | 0.25 | wt % | 0.1 | wt % | 0.5 | wt % | 0.15 | wt % |
| Hydroxyethane di(methylene | 0.5 | wt % | 0.75 | wt % | 0.25 | wt % | 0.2 | wt % |
| phosphonic acid) | | | | | | | | |
| Fluorescent whitening agent | 0.5 | wt % | 0.75 | wt % | 0.25 | wt % | 0.15 | wt % |
| Silicone suds suppressing agent | 0.05 | wt % | 0.10 | wt % | 0.02 | wt % | 0.02 | wt % |
| Photobleach | 0.025 | wt % | 0.050 | wt % | 0.02 | wt % | 0.0015 | wt % |
| Water, filler (including sodium | to 100 | wt % | to 100 | wt % | to 100 | wt % | to 100 | wt % |
| sulphate) and miscellaneous | | | | | | | | |

1. A composition comprising:
(i) a pre-formed peroxyacid or salt thereof in molecularly encapsulated form; and
(ii) a bleach catalyst that is capable of accepting an oxygen atom from a peroxyacid and transferring the oxygen atom to an oxidizeable substrate.

2. A composition according to claim 1, wherein the bleach catalyst comprises an iminium and/or a carbonyl functional group.

3. A composition according to claim 1, wherein the bleach catalyst comprises an oxaziridinium and/or a dioxirane functional group, and/or is capable of forming an oxaziridinium and/or a dioxirane functional group upon acceptance of an oxygen atom.

4. A composition according to claim 1, wherein the bleach catalyst has a chemical structure corresponding to the chemical formula: 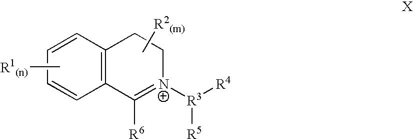
wherein: n and m are independently from about 0 to about 4; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals, and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxy, arylcarbonyl groups, carboxyalkyl groups and amide groups; any R² may be joined together with any other of R² to form part of a common ring; any geminal R² may combine to form a carbonyl; and wherein any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or about 1, and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}-[(CR⁹R¹⁰)_{y}—O]ₖ —R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubsituted said moieties having less than about 21 carbons; each G is independently selected from the group consisting of CO, SO₂, SO, PO and PO₂; R⁹ and R¹⁰ are independently selected from the group consisting of hydrogen and C₁-C₄ alkyl; R¹¹ and R¹² are independently selected from the group consisting of hydrogen and alkyl, or when taken together may join to form a carbonyl; b=0 or about 1; c can=0 or about 1, but c must=0 if b=0; y is an integer of from about 1 to about 6; k is an integer of from 0 to about 20; R⁶ is H, or an alkyl, aryl or heteroaryl moiety; said moieties being substituted or unsubstituted; and X, if present, is a suitable charge balancing counterion.

5. A composition according to claim 1, wherein the bleach catalyst has a chemical structure corresponding to the chemical formula: 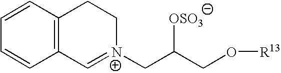
wherein R¹³ is a branched alkyl group containing from about 3 to about 24 carbons, or a linear alkyl group containing from about 1 to about 24 carbons.

6. A composition according to claim 1, wherein the bleach catalyst has a chemical structure corresponding to the chemical formula: 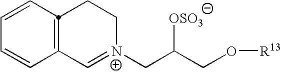
wherein R¹³ is selected from the group consisting of 2-butyloctyl, 2-pentylnonyl, 2-hexyldecyl, iso-tridecyl and iso-pentadecyl.

7. A composition according to claim 1, wherein the pre-formed peroxyacid or salt thereof is the guest molecule in a host-guest complex.

8. A composition according to claim 7, wherein the host molecule is capable of forming intermolecular hydrogen bonds.

9. A composition according to claim 7, wherein the host-guest complex is a clathrate compound.

10. A composition according to claim 7, wherein the host molecule is urea and the host-guest complex is a clathrate compound.

11. A composition according claim 7, wherein the host-guest complex is at least partially coated by a coating ingredient.

12. A composition according to claim 11, wherein the coating ingredient is substantially incapable of forming hydrogen bonds.

13. A composition according to claim 11, wherein the coating ingredient is a paraffin wax.

14. A composition according to claim 11, wherein the host-guest complex is in an intimate mixture with a source of acid.

15. A composition according to claim 1, wherein the composition comprises a pre-formed peroxyacid in a sufficient amount so as to provide from above 0% to about 0.2%, by weight of the composition, of available oxygen.

16. A composition according to claim 1, wherein the composition comprises less than about 5%, by weight of the composition, of a source of peroxygen.

17. A composition according to claim 1, wherein the composition comprises from about 5% to about 10%, by weight of the composition, of a source of carbonate anion.

18. A composition according to claim 1, wherein the composition comprises a dye transfer inhibitor.

19. A composition according to claim 1, wherein the composition comprises:
(i) less than about 5%, by weight of the composition, of zeolite builder;
(ii) optionally, less than about 5%, by weight of the composition, of phosphate builder; and
(iii) optionally, less than about 5%, by weight of the composition, of silicate salt.

20. A composition comprising:
(i) a clathrate compound obtainable by contacting a preformed peroxyacid or salt thereof with urea; and
(ii) a bleach catalyst that is capable of accepting an oxygen atom from a peroxyacid and transferring the oxygen atom onto a substrate to be bleached.
